(19) United States
(12) Patent Application Publication
(10) Pub. No.: US 2015/0062859 A1
(43) Pub. Date: Mar. 5, 2015

(54) SOLAR POWERED LIGHTING SYSTEM

(71) Applicant: KIMBERLEY PLASTICS PTY LTD, Victoria (AU)

(72) Inventor: Brian Kimberley, Victoria (AU)

(21) Appl. No.: 14/385,362

(22) PCT Filed: Mar. 12, 2013
(86) PCT No.: PCT/AU2013/000244

§ 371 Date: Sep. 15, 2014

(30) Foreign Application Priority Data
Mar. 13, 2012 (AU) 2012901000

(51) Int. Cl. F21S 9/03; F21S 8/04; F21S 8/00; F21V 23/00

(52) U.S. Cl. CPC F21S 9/032; F21V 23/003; F21S 8/04; F21S 8/033
USPC 362/1

(57) ABSTRACT

A solar powered lighting system includes a solar module adapted to receive solar energy and transform received solar energy into electrical energy and a lighting module. The lighting module is electrically coupled to the solar module and is configurable to emit light using electrical energy generated by the solar module only while the solar module receives solar energy. The solar module and the lighting module are electrically couplable such that light emitted from the lighting module mimics a characteristic of sunlight from which the solar energy is received.

### FIELD OF THE INVENTION

This invention relates to lighting systems which are powered by solar energy. It relates particularly but not exclusively to solar powered interior lighting systems for use e.g. as skylights which mimic one or more characteristics, such as brightness or colour, of external ambient sunlight.

### BACKGROUND TO THE INVENTION

Electricity consumption is one factor that contributes to pollution and carbon emissions which in turn are believed to contribute to global warming. Consequently, consumers are becoming increasingly concerned with the environment and how day to day energy usage influences greenhouse gas and other emissions. To meet consumer expectations, manufacturers and designers of consumer products strive to improve their product offering not only on price, but also having regard to energy efficiency, reducing carbon footprint and showing general environmental awareness.

Like rain water harvesting, the desire to harvest energy from natural resources such as the sun and wind, has gained interest in recent times. Use of solar panels has become particularly prevalent and encouraged through Government grant and rebate programs designed to incentivise their uptake. Typically, the solar panels for which Governments provide financial support are larger and quite expensive. However, smaller, more affordable solar panels are also popular among consumers whose power requirements are lower and where use of solar energy is convenient e.g. to power appliances in caravans, motor homes, while camping and the like.

New approaches to lighting technology have also enjoyed advancement in recent years. One form of lighting technology which employs light emitting diodes (LEDs) has seen an increase in popularity. This is in part due to their efficient energy consumption and low heating profile and more recently, due to the array of colours and light intensities that can be emitted from commercially available devices.

Despite these technological advances, approaches to energy efficient interior lighting systems, such as natural skylights, have maintained their relevance particularly in the domestic housing environ. An advantage of using a natural skylight systems compared to energy efficient electric lighting systems is that there is no energy requirement whatsoever. Rather, external ambient sunlight is directed from a roof-mounted dome through an optical pathway to a diffuser which diffuses the light for enjoyment inside the dwelling. However, installation of the components necessary to achieve this ‘skylight’ effect can be expensive and involve significant modification to the roof and ceiling of the building structure.

Installation of traditional skylights can affect the integrity of the roof since a sizeable hole must be made for the external dome and despite use of flashing and sealants, this can cause leaks. Additionally, the roof space into which the optical pathway is installed must be cleared to accommodate the tube through which the light is channeled. Accordingly, the interior position of traditional skylights is limited by the location of existing wiring and appliances in the roof space, as well as upper levels in the building. Further, removal or repair of a traditional skylight is not straightforward.

The present invention aims to provide a lighting system which may be used an alternative to the traditional, natural-light skylight.

The discussion of the background to the invention included herein including reference to documents, acts, materials, devices, articles and the like is intended to explain the context of the present invention. This is not to be taken as an admission or a suggestion that any of the material referred to was published, known or part of the common general knowledge in Australia as at the priority date of any of the provisional claims appended hereto.

### SUMMARY OF THE INVENTION

Viewed from one aspect, the present invention provides a solar powered lighting system including a solar module adapted to receive solar energy and transform received solar energy into electrical energy; and a lighting module electrically coupled to the solar module. The lighting module is configurable to emit light using electrical energy generated by the solar module only while the solar module receives solar energy. Thus the solar module and the lighting module are electrically couplable such that light emitted from the lighting module mimics a characteristic of sunlight from which the solar energy is received. A characteristic of natural sunlight which is mimicked by the lighting module may include but is not limited to e.g. brightness and colour.

The system may also include a regulator adapted to limit electrical energy supplied to the lighting module from the solar module. Preferably, the regulator limits maximum amount of current supplied to the lighting module to minimise heating of and/or damage to one or more light emitters in the lighting module. It is to be understood, however, that the regulator may alternatively and/or additionally limit voltage (i.e. potential difference) used to energise the lighting module.

The lighting module may include any suitable light emitters including incandescent and fluorescent lights. In a preferred embodiment, the lighting module includes an illumination element having one or more LEDs. The LEDs may be arranged in any suitable manner such as e.g. along a strip and or around a perimeter of the lighting module and/or in an array over at least an area of the lighting module. A diffuser may also be provided, for diffusing light emitted from the lighting module.

In some embodiments it is important that the lighting module has a low or thin profile. This enables the lighting module to be installed e.g. beneath a ceiling joist, between wall studs or where there is a space constriction at the rear and/or front of the device. In other cases, it is desirable for aesthetic reasons for the lighting module to have a low profile. In these embodiments, it is preferred that the LED light emitters are Surface Mount Diodes (SMDs) or strip LEDs or a combination of such emitters. These enable the lighting module to be provided in a “flat panel” format. In some embodiments, the LEDs are arranged around a perimeter of the lighting module and are directed inwardly.

In some embodiments it is desirable that the emitters of the LEDs are directed toward an interior the lighting module. Thus, where the lighting module comprises one or more frame members, LED strips may be adhered to or arranged along the frame member so that they direct light inwardly, i.e. substantially parallel to the ceiling or wall surface when the lighting module is mounted, with the LEDs emitting light inwardly of the frame member. Alternatively or additionally, the LED strips may be adhered or arranged along a surface of the lighting module (or framework or other component associated with it) such that the LEDs emit light away from the lighting module (e.g. substantially orthogonal to the ceiling or wall surface when mounted) and into the room or space into which the lighting module is installed.

The light emitters may emit light at a single wavelength, or they may be controllable to operate light at different wavelengths. Alternatively, the lighting module may include LEDs adapted to emit light at one or more particular wavelengths and other LEDs adapted to emit light at one or more other wavelengths and which, when operatively combined, enable a broader spectrum of light colours and brightnesses to be created. Thus, the lighting module may be operably coupled with a controller (such as a microcontroller) that causes the LEDs to emit light at wavelengths and/or brightnesses that create a lighting effect that, in some embodiments, may give the impression of an image. Such images may include e.g. an external landscape or sky-scape, presenting the illusion of a transparent window or ceiling panel.

In one embodiment, the lighting module is configured for installation in a wall or ceiling sheet adjacent a support beam such as a ceiling joist or wall stud. In this embodiment, the lighting module has a casing at least a portion of which has a thickness less than or equal to the wall or ceiling sheet thickness. Thus, at least a portion of the casing has a thickness of less than 20 mm, preferably less than 15 mm and more preferably less than or equal to 12 mm, 10 mm or 8 mm. This is facilitated by use of low profile LEDs such as strip LEDs 800 (FIGS. 10a, 10b) and SMDs 810 discussed above such that the overall thickness of the lighting module is less than e.g. 50 mm ideally less than 35 mm such as e.g. about 25 mm. It is to be understood that the overall thickness of the lighting module may be as little as 12 mm or 8 mm or less depending on the components used.

Preferably, the lighting module is configured to protrude minimally from a mounting surface (such as a wall or ceiling sheet) to which the lighting module has been mounted. Thus the module may be sufficiently thin that it can be recessed into a wall/ceiling. Fasteners such as screws, spring clips and/or adhesive may be used to fasten the lighting module in position. In one embodiment, a plurality of spring clips is provided e.g. on the rear casing of the lighting module, for releasably mounting the lighting module in a wall or ceiling sheet or structure.

In one embodiment, the inventive solar powered lighting system is couplable with a secondary power source. The enables the lighting module to be activated in the absence of solar energy. The lighting system may also include a switching module operable by a user. The switching module may facilitate connection and disconnection of the lighting module from a power source such as the solar module or a secondary power source, and/or switching between power sources e.g. the solar module and a secondary power source. The switching module may include one or more wall mounted switches or a wireless switch operable by the user using e.g. a remotely controlled hand held unit. Alternatively/additionally, the switching module may be provided with an automated switching means adapted for light-dependent (via an externally located light sensor) or time-dependent (via a timer) operation. The light or time dependency determines when a controller controls switching of the power source between solar and other sources.

In some embodiments, the solar powered lighting system includes a controller configured to control operation of the lighting module to produce a particular lighting effect. The lighting effect may be a substantially natural ambient light effect, an image, a colour effect, or an image or colour effect that changes over time. The controller may receive image data for the lighting effect from e.g. a memory device couplable with the controller and/or a camera or other image capture device which is couplable with the controller.

### BRIEF DESCRIPTION OF THE DRAWINGS

The invention will now be described in greater detail with reference to the embodiments shown in the accompanying drawings. It is to be understood that these embodiments are examples only and that they do not limit the scope of the invention as it is defined in the claims appended hereto.

FIG. 1 is a schematic illustration of component parts of a lighting system according to an embodiment of the invention.

FIG. 2 is a schematic illustration of a lighting system together with parts of a roof and ceiling into which the solar and lighting modules of the invention are installed, respectively.

FIG. 3 is a side view of a lighting module installed in a ceiling sheet, according to an embodiment of the invention.

FIGS. 4a to 4c show rear, side and end views of a lighting module having a round diffuser panel, according to an embodiment of the invention.

FIGS. 5a to 5c show rear, side and end views of a lighting module having a square diffuser panel, according to an embodiment of the invention.

FIG. 6 is a schematic diagram of a regulator circuit according to an embodiment of the invention.

FIGS. 7a to 7e illustrate different embodiments of a solar-powered lighting module configured for use as a window feature and having a simple 10 mm frame, according to embodiments of the present intention.

FIGS. 8a and 8b illustrate different embodiments of a solar-powered lighting module configured for use as a window feature and having a thicker, 90 mm timber frame for recessed installation into a stud wall.

FIGS. 9a and 9b show a lighting module having a timber architrave frame; FIG. 9b shows the lighting module installed in a stud wall.

FIGS. 10a and 10b are isometric and top views respectively of strip LEDs for use with embodiments of the present invention.

### DETAILED DESCRIPTION

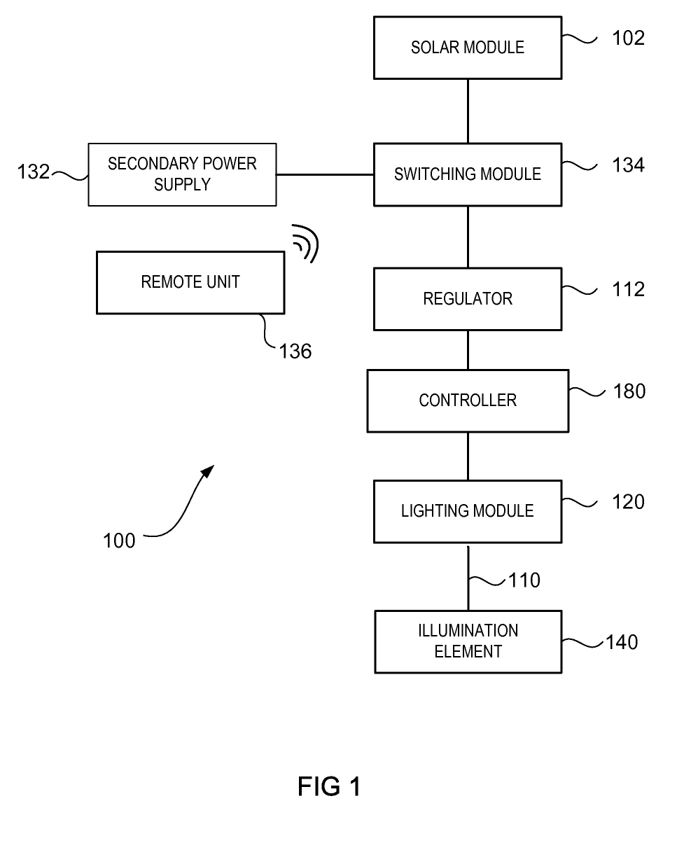

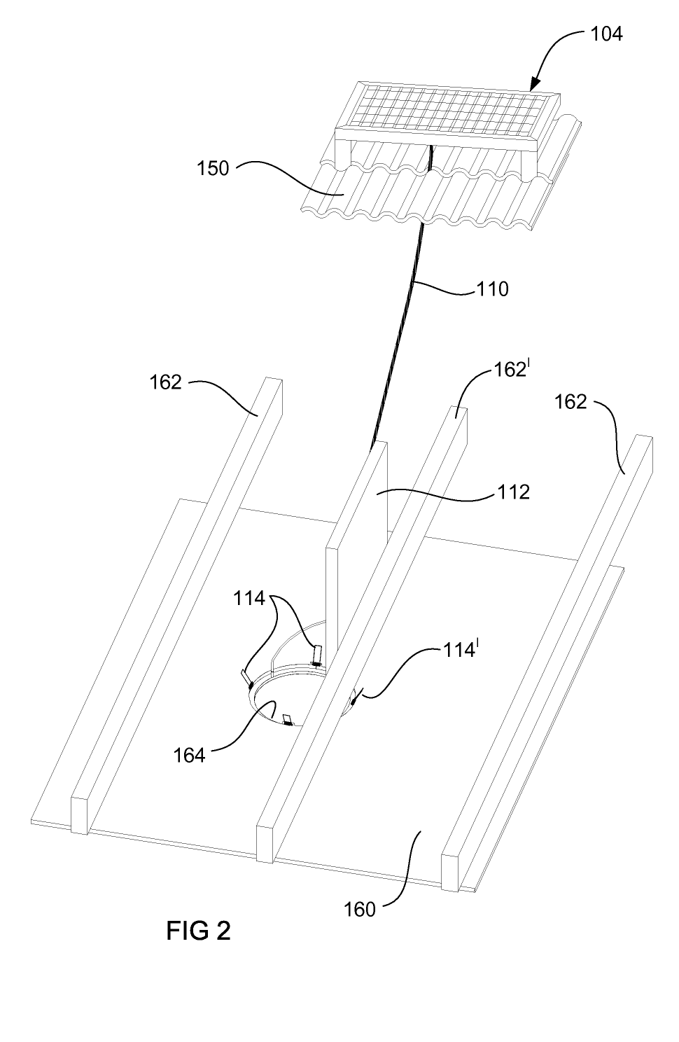

Referring firstly to FIG. 1, there is shown a schematic illustration representing component parts of a solar powered lighting system 100, according to an embodiment of the invention. Solar module 102 includes a solar panel 104 (FIG. 2) comprising a plurality of solar cells, also known as photovoltaic cells. Typically, the individual solar cells of the solar module generate electricity using light energy from the sun. However, it is conceivable that solar module 102 also generates electricity from heat energy from the sun. Typically, the output from the solar module is a DC current.

Given that the intensity of light (and heat) emitted from the sun fluctuates during the course of a day, the electrical energy produced by solar module 102 also fluctuates. Beneficially, the solar module and the lighting module are coupled in such a way that fluctuations in sun light (and/or heat) affect the intensity with which the lighting module emits light. That is, the lighting module is electrically coupled to the solar module through an electrical coupling, typically a wire, represented by reference numeral 110. The electrical energy supplied to the lighting module 120 from the solar module 102 is proportional to the amount of energy being generated by the solar module 102, which in turn is proportional to the amount of solar energy it receives.

Typically, lighting module 120 is installed inside a building structure, ideally in a ceiling or wall panel although use of the inventive lighting module in alfresco, patio and other semi-enclosed areas is also contemplated. Most often, the lighting module would be installed in a ceiling of a domestic dwelling or commercial structure, as is the case with traditional skylights. The coupling 110 between solar module 102 and lighting module 120 enables the lighting module to be configured to emit light of varying brightness, according to the varying brightness of the sunlight outside. That is, light emitted from the lighting module 120 mimics a characteristic, such as e.g. brightness, of the natural sunlight outside, subject to it not exceeding the power rating of the lighting module.

The coupling 110 connecting the solar module 102 and lighting module 120 is typically an electrical wire installed beneath roofing tiles, slates, shingles or roofing sheets 150 and fed through the roof space to the point of installation of the lighting module 120 in ceiling 160. An advantage of this arrangement is that there is no need for an optical pathway between external solar panel 104 and the internal lighting module 120 of the solar powered lighting system 100. Thus, unlike traditional skylight systems, the external component may be installed e.g. on a northern aspect of the roof while the interior component may be installed in any ceiling or wall section in any part of the building.

This facilitates installation of the inventive solar powered lighting system in rooms where installation of traditional skylights would be inefficient or virtually impossible. Such locations include e.g. cellars, basements and underground dwellings, where there are upper stories in the building, existing appliances such as heating/cooling units, hot water systems and attic storage, and/or wiring which obstructs installation of a traditional skylight. In these scenarios, lighting systems according to embodiments of the present system which mimic the lighting effect of traditional skylights may be installed with ease. Furthermore, the present invention enables enhanced brightness in rooms which, using the traditional skylight system, would only experience limited natural illumination because of the orientation of the external dome of the traditional skylight.

Typically, the solar module 102 is selected with a power rating which is suitable for the lighting module 120 with which it used. In some arrangements, a single solar module may be suitable for powering multiple lighting modules. Such a solar module may have a rating of 5 W to 5,000 W or higher, depending on the power requirements of the lighting module/s with which the solar module is coupled. The multiple lighting modules may be connected to the single solar module, typically in parallel. Normally the output of photovoltaic cells of the kind that may be employed in the solar module varies according to the sunlight conditions. In some situations the power output from the solar module, e.g. on particularly bright days, may exceed the power rating of the lighting module. Thus, in a preferred embodiment, the inventive solar powered lighting system includes a regulator or limiter 112 which limits the amount of power which can be drawn by the lighting module. A battery (not shown) may be provided in some embodiments to store excess energy which may be supplied to any appliance, including e.g. the lighting module.

Use of a regulator or current limiter may be particularly desirable in an embodiment in which the lighting module includes an illumination element comprising LEDs since LEDs drawing excess current tend to overheat and degrade or expire prematurely. In this embodiment, regulator 112 typically comprises a voltage and/or current limiting circuit which ensures that the voltage and/or current available to the lighting module 120 does not exceed a pre-determined limit. This prevents the LEDs from drawing more current than they are rated to receive.

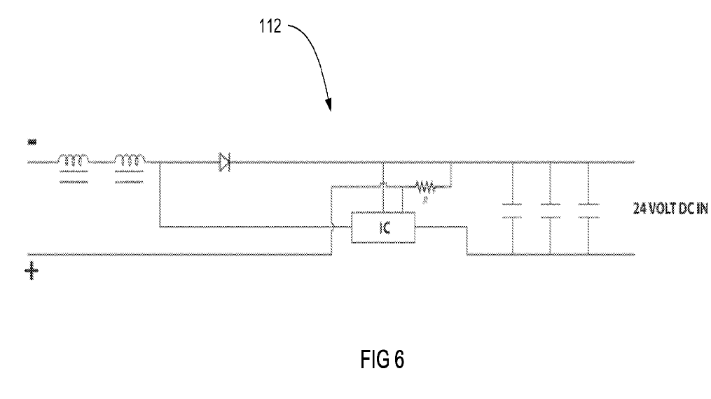

The regulator circuit may limit current supplied to the lighting module 120 by including a resistor for dissipating excess energy so that the current supplied to the lighting module cannot exceed the ideal operating threshold of the LEDs. Alternatively, a diode, active power control or other approaches may be used to limit power supplied to the lighting module, as would be understood by one of skill in the art. An example of a regulator circuit is provided in FIG. 6. Such a circuit may be referred to as a “constant current module”, but one which allows output voltage to drop until the available energy to the lighting module is no longer sufficient to power the illumination element, in which case it is extinguished. Other examples of regulator circuits known to one of skill in the art include current-limiting circuits and foldback limiting circuits, the latter regulating both output voltage and output current.

It is to be noted, however, that the intended function of regulator 112 is to limit the maximum power supply to the lighting module. It is not necessary for the regulator to pull up the current supplied to the LEDs to a minimum level. In fact, it is desirable for the power supplied to the lighting module to vary in accordance with the amount of power being generated by the solar module 102, and in turn, to vary in accordance with the solar energy received. In this way, light emitted from the lighting module 120 varies to substantially mimic the behaviour of natural sunlight outside.

In an embodiment, additional optional illumination elements 140 may be provided. The illumination elements 140 may present extra load for dissipating excess power from the solar module. Alternatively/additionally further lighting modules 120 may be desired, to provide a secondary source of light in addition to the main lighting module. Furthermore, additional (i.e. multiple) or larger solar modules 102 may be provided for supplying extra power where more than one lighting module 120 is installed. Additional solar modules may be offered as an “optional extra” or installed subsequent to the main solar module, typically installed in parallel.

In some embodiments, a secondary power supply 132 may be provided. The secondary power supply may be e.g. mains power with a DC adaptor, or it may include e.g. a 9, 12 or 24 volt battery e.g. of the kind used to power emergency lighting installations. The battery is selected according to the size and power requirement of the illumination element 140 and any optional/additional illumination elements or lighting modules that are coupled to the battery and may, in some embodiments, be chargeable with solar or other energy. Where a secondary power source is provided, the inventive lighting system may be used in two modes of operation.

In a first mode, the lighting system mimics natural light by powering the lighting module 120 in accordance with fluctuations in electrical energy generated by the solar module 102 (and in accordance with fluctuations in solar energy received by the solar module). Alternatively, an external light sensor may be provided, which senses natural sunlight conditions. The sensor output may be used to control the light emitted from the lighting module. Alternatively, a timer or clock could be used to determine when the lighting module should be powered by solar or other secondary power such as batter or mains electricity. In a second mode, the lighting system can be used ‘on command’ by operating a switch which enables the lighting module 120 to be powered from a secondary power supply 132. When powered by a secondary power supply, the lighting module may be activated to emit light when there is no sunlight outdoors.

Thus, as well as using the lighting module as a natural skylight or window structure, when the source of natural power (i.e. sunlight) is removed such as at night time, the lighting module 120 may be used as a ceiling light as opposed to a skylight, by use of power from the secondary power supply which may be under e.g. light or time dependent control.

In order to control operation of the lighting module in this way, a switching module 134 may be employed. In one embodiment, the switching module provides means to switch power sources from which the lighting module 120 is powered. In another embodiment, the switching module 134 merely opens and closes a switch between the solar module 102 and the lighting module 120 to effectively de-couple the lighting module from its solar power source. This may be desirable on days where total darkness is required inside the building. This feature may give a further advantage over traditional skylights which cannot be extinguished except by use of a block-out curtain or blind or other physical cover. The switching module may be computer controlled in such a way that there is automatic switching between primary and secondary power supplies, based on user, time, light levels or other specified requirements.

In one embodiment, the switching module 134 includes a wall mountable switch. Alternatively, a wireless i.e. remote control switch may be used, employing e.g. radio frequency or infrared transmission of control signals from a remote unit 136 to a receiver associated with the switching module 134.

Referring now to FIG. 2, there is shown a solar panel 104 of a solar module 102 installed on a section of roofing iron 150. Electrical coupling 110 extends from solar panel 104 through a gap between sheets of roofing iron 150 to the rear of a sheet of ceiling plaster 160, where the lighting module 120 is to be installed.

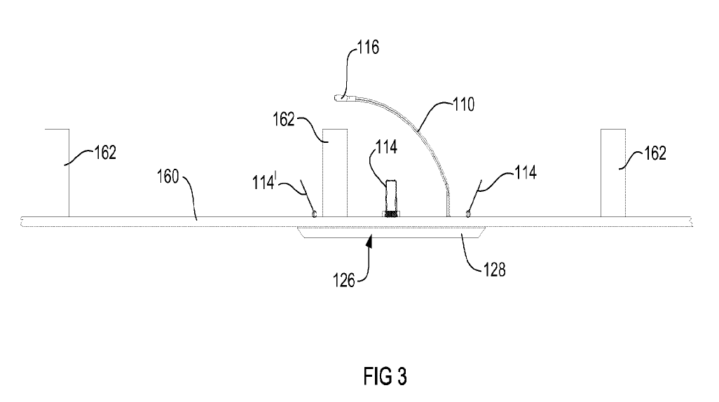

In an embodiment, the lighting module 120 includes an illumination element 126 (refer FIG. 3) comprising a plurality of LEDs. Ideally, the illumination element sits on the surface of a ceiling or wall plaster/cement sheet. To install the lighting module in this way requires only a small hole in the ceiling to feed the wire coupling 110 through the ceiling. The illumination element and/or other components of the lighting module can be screwed, glued or otherwise attached to the surface of the ceiling or wall plaster.

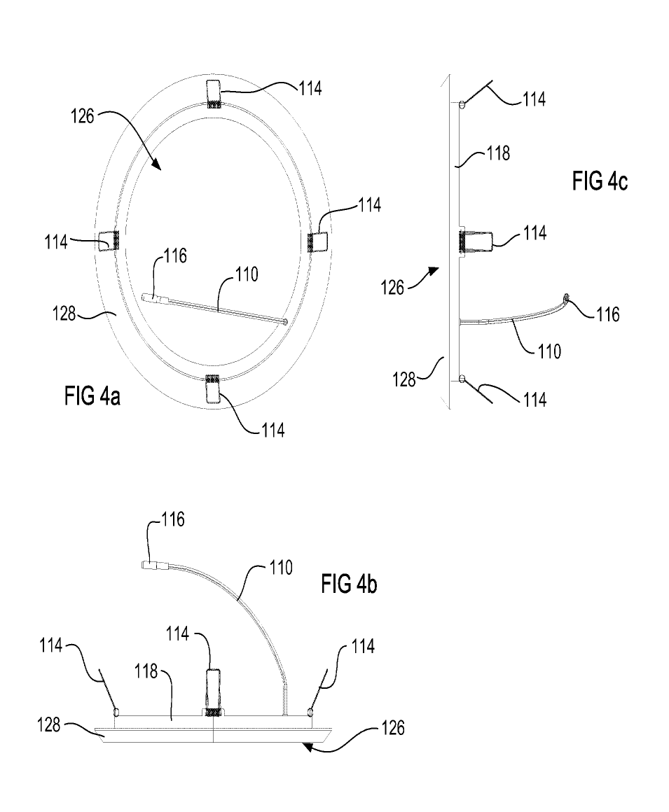

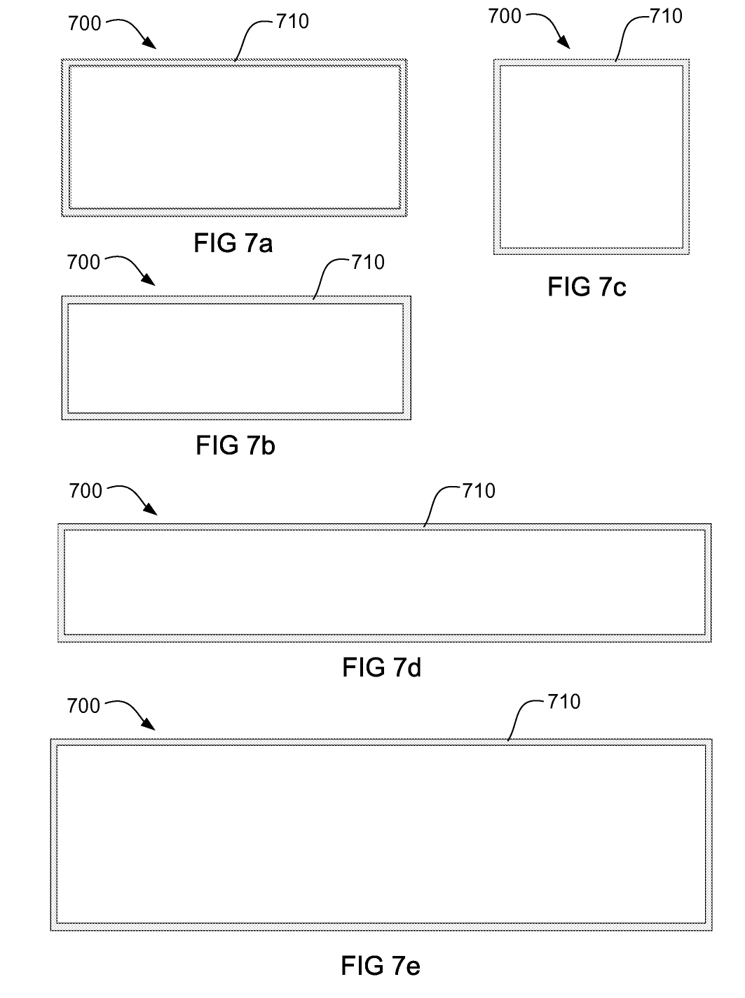

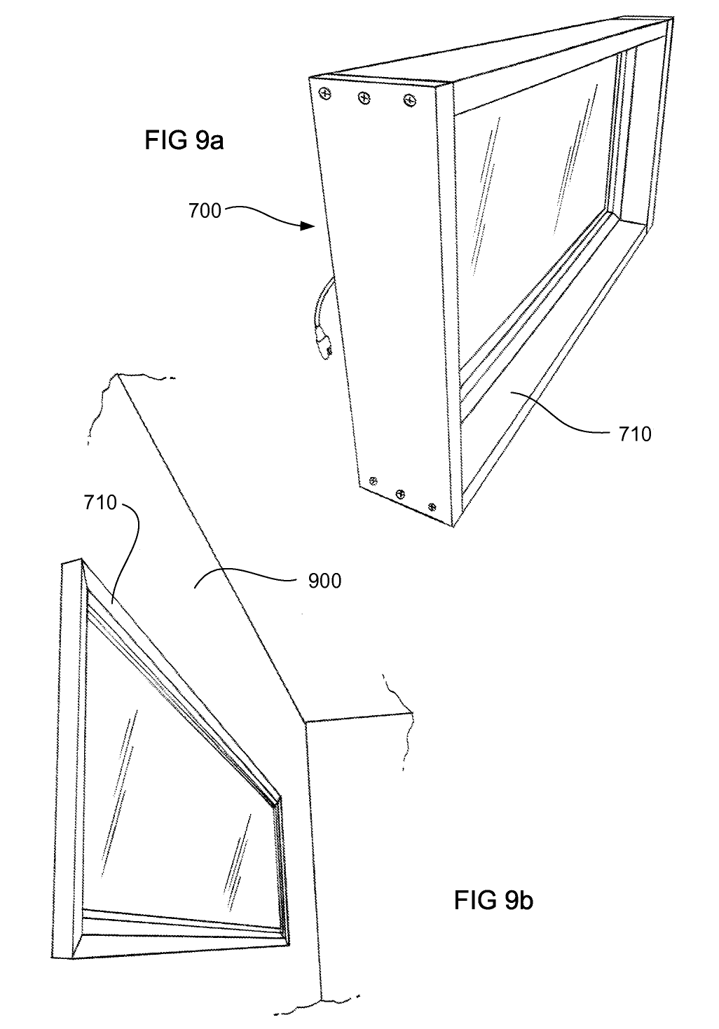

However, in a preferred embodiment such as the kind illustrated in the drawings, a larger hole 164 may be formed in the ceiling or wall sheet which is designed to receive a rear casing 118 (refer FIG. 4) of the lighting module 120 so that it is at least partly recessed into the ceiling or wall sheet 160. This is made possible in part due to the nature of LEDs and the thin strip form in which they are employed, which provides a low profile illumination element compared with incandescent and fluorescent tube lighting installations and also when compared with traditional LED “globes”. Recessing the lighting module 120 in this way improves the look of the lighting system 100. See for example the “window” style installation into stud wall 900, shown in FIGS. 9a and 9b. Other shapes and configurations of window-type installations are shown schematically in FIGS. 7a to 7e although the selection illustrated are for example only, and in no way limit the range of sizes and shapes that could be offered.

A thin light diffuser 126 is typically arranged within frame 128. In an embodiment, the frame 128 forms a flange or lip for supporting the lighting module 120 when installed, such that spring clips 114 mounted internally the roof space frictionally engage the ceiling plaster 160 between the rear of diffuser frame 128 and the clips 114. In other embodiments, the diffuser and frame are recessed into the plaster when installed so that only a very thin bezel portion protrudes from the plaster surface when installed in a wall or ceiling sheet.

The extent to which the lighting module protrudes from the wall or ceiling surface may be dictated by e.g. aesthetic factors and practical factors such as whether or not the lighting module can be recessed by forming a hole in the mounting surface. In the case of solid brick walls for example, it may not be possible or viable to form a recess for mounting the lighting module, in which case the frame and diffuser will be applied to the wall surface and anchored in place by screws, bolts, adhesive or the like, and it will protrude from the wall. An adaptor plate may be used for mounting the lighting module on a surface of e.g. a cement roof (e.g. of a basement car park) or brick wall. Beneficially, the novel low profile design of the lighting module limits the extent to which the module protrudes from the mounting surface. This is significantly less than traditional light fittings containing incandescent and fluorescent lamps.

In FIG. 2, hole 164 has been formed in the ceiling sheet 160 by cutting using a knife or other tool. The location for placement of the lighting module includes a section of ceiling sheet 160 adjacent to a ceiling support beam 162 to which the ceiling sheet is attached. Clips 114 retain the lighting module 120 within the hole 164 formed in ceiling sheet 160. One of the clips 114′ is shown to the left of support beam 162′ while the remaining three clips 114 are to the right of support beam 162′. Once installed, part of the lighting module 120 sits in the hole formed in the ceiling sheet, recessed within the hole beneath in abutment with support beam 162′.

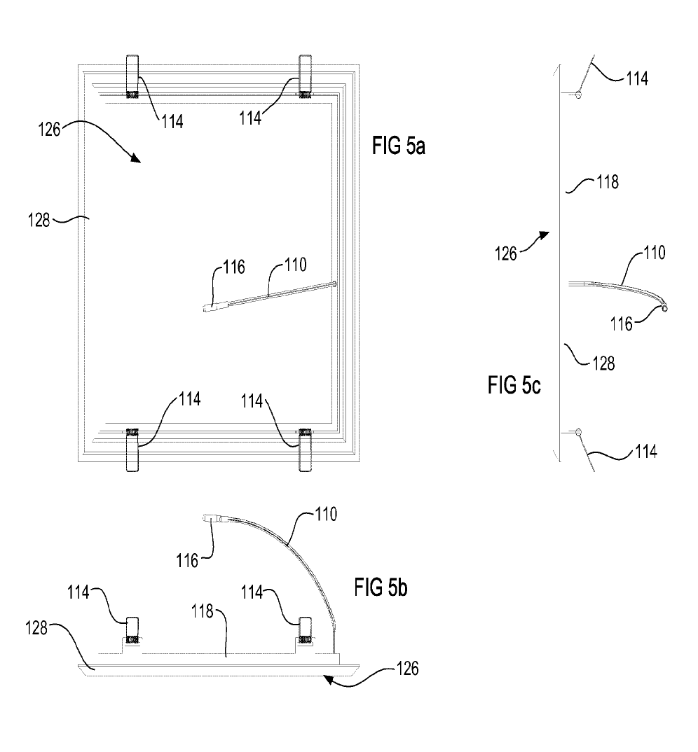

LEDs in an illumination element of the lighting module may be provided in any arrangement. In an embodiment, the LEDs are provided along one or more edges of the illumination element, or the illumination element is a strip or member to which the LEDs are applied. This is particularly useful where the lighting module is square in shape (see for example FIGS. 5a to 5c). In this arrangement, the LEDs can be arranged in lines e.g. along two opposing edges of a frame work of the lighting module, thus forming two illumination “elements”. Alternatively, the LEDs may be arranged around a perimeter of the lighting module. This may be particularly useful e.g. in the case of round lighting modules of the kind illustrated in FIGS. 4a to 4c. Alternatively/additionally, the LEDs may be arranged in any desirable configuration, thus providing one or more illumination elements inside the perimeter of the lighting module. Ideally, the LEDs are directed inwardly.

Strip LEDs 800 of the kind shown in FIGS. 10a, 10b may be particularly suitable for use in the illumination element/s as they can be applied e.g. using adhesive which streamlines assembly. Strip LEDs comprise a plurality of surface mount diodes (SMDs) 810 mounted on a supporting member 820 adapted to conduct power to each LED. Current applied is to the strip by connectors 830 that are electrically coupled with power from the solar module 102 by plug 116.

Preferably, lighting module is low profile. That is, it is thin enough to be recessed into a wall or ceiling panel such that only a relatively thin portion of the module protrudes from the mounting surface if any at all. To achieve a low profile, it is desirable that the light emitters are of a low profile variety, such as in LED strip lighting and/or LEDs of the surface mountable type that are very thin. In some embodiments, the LED strips are provided with an adhesive on one side so that they are readily assembled into the lighting module. An example of LED strips 800 of the kind that may be used is illustrated in FIGS. 10a and 10b. In other embodiments, the LEDs may be provided individually, or in sets of strips, e.g. where LEDs with different wavelength and brightness specifications are used.

It is to be understood that although embodiments of the invention described herein relate to LED lighting technology, it is to be understood that the invention is translatable across a range of lighting techniques. These techniques include but are not limited to LED, incandescent, plasma and other lighting technologies as would be understood by one of skill in the art.

In a preferred embodiment, the lighting module includes a diffuser 126 which diffuses light emitted from the illumination element so that there is gentle and consistent lighting effect emitted from the lighting module 120. In an embodiment, the diffuser 126 includes a frame 128 which provides a neat presentation finish to the lighting installation. Ideally, when the lighting module 120 is installed into a ceiling, the diffuser frame 128 sits on the surface of the ceiling so as to neatly finish the hole into which the module is installed.

In an embodiment, lighting module 120 has a rear casing 118 having a thickness, at least in a region of the rear casing, which is thin enough to be recessed within the thickness of a ceiling (or wall) sheet 160. Thus, the rear casing 118 or at least a portion of it can be recessed into plaster 160 so that the lighting module 120 can be installed in a region which includes a support beam or other obstruction adjacent the ceiling or wall sheet. To this end, a portion of the rear casing 118 may have a thickness which is e.g. less than 20 mm or more preferably, less than 15 mm. Given that most ceiling sheets are approximately 10 mm thick, it is desirable in some embodiments for at least a portion of the rear casing 118 of the lighting module 120 to have a thickness no more than or equal to about 8 mm to 10 mm. Clips 114 provided on the rear casing 118 may be used to retain the lighting module 120 in position. Ideally, the light emitting side of the lighting module does not protrude significantly from the ceiling or wall sheet. In preferred embodiments the lighting module may sit almost flush with the ceiling/wall surface when installed.

Ideally, clips 114 are spring mounted clips biased in such a way that a portion of the ceiling plaster sheet is retained between the clip 114 and a corresponding section of lighting module mounted inside the room, e.g. diffuser frame 128. The frictional force provided between e.g. the diffuser frame 128 and clips 114 is sufficient to retain the lighting module 120 in position. Other forms of installation are also contemplated e.g. as in the window effect installation discussed below.

Coupling 110 in the form of an electrical wire extends from the rear casing 118 for connection with the solar module. In the embodiments illustrated in FIGS. 3, 4a to 4c and 5a to 5c, a plug 116 is provided to couple lighting module 120 with a socket (not shown) in solar module 102. In a preferred embodiment, regulator 112 is connected between the lighting module 120 and the solar module 102 so as to limit current supplied from the solar module to the LEDs in the lighting module.

As discussed previously, switches may be provided to connect and disconnect power from the solar module 102 to the lighting module 120. Alternatively/additionally, a switching module 134 may be used to connect the lighting module 120 with a secondary power supply 132 such as mains power or a battery and/or a controller 180. The battery may be e.g. a 24 volt battery charged from the solar module 102 although it is to be understood that the battery may be of any kind capable of providing the power necessary to operate the lighting module 120.

FIGS. 4a to 4c and 5a to 5c show different arrangements of diffuser 126 and diffuser frames 128 which may be employed with the lighting module 120 of the present invention. The embodiments shown in FIGS. 4a to 4c show a round diffuser 126 and diffuser frame 128 with round rear casing 118. Meanwhile FIGS. 5a to 5c show a square diffuser 126 and diffuser frame 128 with square rear casing 118. It is to be understood that the illumination element, diffuser and diffuser frame may be provided in any desirable closed polygonal shape. The illumination element need not be the same shape as the diffuser and diffuser frame. Thus, although circular and square shapes are illustrated in the drawings, it is to be understood that any one or more of e.g. oval, rectangular, triangular, hexagonal, octagonal, elliptical and other shapes may be provided.

Similarly, the dimensions of the lighting module including the illumination element, diffuser and diffuser frame may be selected according to the requirements of the room into which the module is installed. Diffuser/diffuser frames having a dimension as small as 100 mm may be provided while sizes of up to 600 mm² or larger (e.g. 600 mm×1200 mm) may also be contemplated. Sizes considered to be particularly useful include 180 mm and 270 mm diameter round diffusers and e.g. 300 mm² and 400 mm² square diffusers although many different sizes and shapes have utility in practice. Clearly, the size of the illumination element (and indeed the number of illumination elements) employed in the lighting module 120 influences the amount of power drawn by the lighting module and this in turn influences the size of the solar module 102 required to power the system. These factors influence selection of the modules of the lighting system 100 to be installed.

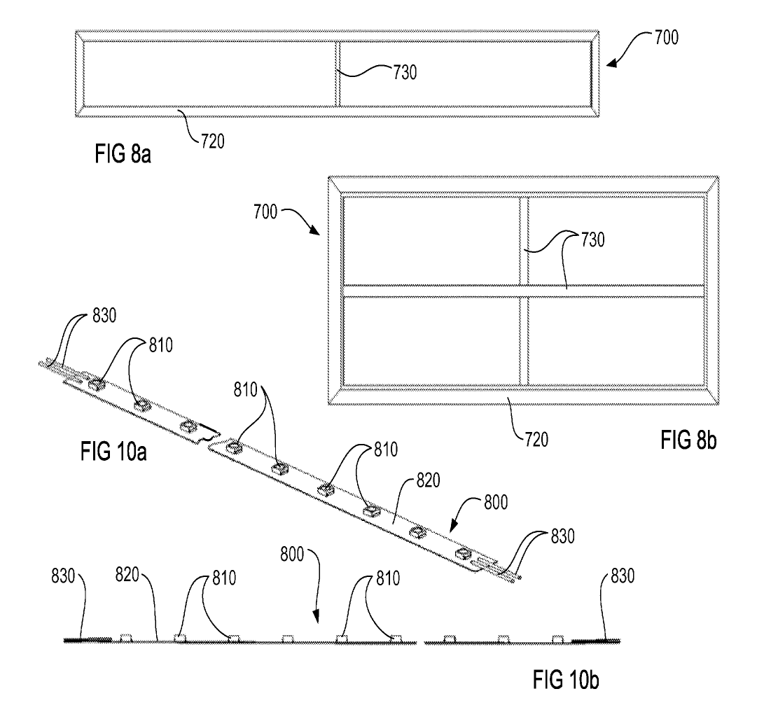

FIGS. 7a to 7e, 8a and 8b show a range of window style lighting modules according to embodiments of the present invention. In one embodiment, the lighting module 700 is mounted just through the wall plaster. A frame 710 may be attached for a finished appearance that gives the effect of a window being installed in the wall. In another embodiment, a 90 mm frame 720 is attached (FIGS. 8a, 8b, 9a, 9b) with miter corners. The thicker frame enables the lighting module to be mounted into stud walls to give the effect of a recessed window. This appearance may be further complimented by internal decorative (or structural) frame members 730.

See FIGS. 8a and 8b. It is to be understood that the window effect may be achieved on internal or external walls. When mounted on the outside of external walls, the window is visible from outside a building giving the appearance of windows to passers-by. This could provide increased security, e.g. to give the illusion of internal lighting. When under e.g. timer control, this could give the impression that the building is occupied. Alternatively/additionally, an externally mounted illumination module may be utilised for aesthetic reasons, e.g. to break up large wall sections. Beneficially, the lighting effect may also be controllable, e.g. to illuminate dark walkways or lanes in an energy efficient, aesthetically pleasing manner.

As indicated above, it is desirable that the light emitted from the lighting module 120 mimics at least one characteristic of sunlight from which the solar energy powering the system is received. Typically, that characteristic is brightness, wherein the brightness of light emitted from the lighting module 120 corresponds to the brightness of sunlight which is received by the solar module 102 and transformed into electrical energy. Thus, the interior lighting effect created by the solar powered lighting system 100 changes throughout the day as the sun rises and falls and as cloud cover diminishes the amount of solar energy received by the solar module 102.

Another characteristic of natural sunlight which may be mimicked by the lighting module is the colour of the light. This may be achieved by providing e.g. cool colour and/or warm colour LEDs in the lighting module. Thus, in some embodiments, it may be desirable to provide two or more sets of LEDs in the lighting module; one set being adapted to emit warmer light to emulate “daylight” when the device is directly solar powered; and the other set/s being adapted to emit cooler light wavelengths. The cooler light wavelengths may be used e.g. at night time when the lighting module is not being powered directly from the solar module to mimic natural lighting effects but is instead being used as a lamp. Alternatively, the light emitters may be dual- or multi-spectrum emitters which are controllable (e.g. via a microcontroller operated by a remote control or switching unit) to emit light at a particular wavelength e.g. at a particular time. Alternatively/additionally, a sensor may be used to detect the extent to which the external ambient sunlight is coloured (e.g. due to pollution or weather) or overcast and this in turn may be used in feedback to the control circuit to colour, soften or sharpen the lighting effect created by the lighting module 120.

Ideally, the illumination element/s employed in the lighting module emits light in a spectrum which is representative of the spectrum of natural daylight so as to give a realistic “natural light” feel. Full spectrum lighting is ideal. In various embodiments, colour temperature ratings in the ranges of e.g. 2700 to 3500 kelvin (for e.g. “warm white” light), 4,000 to 5,000 kelvin (for e.g. “horizon daylight”) and 5,700 to 7,000 kelvin (for “cool white” light) are contemplated although performance of the lighting module is not limited to one or more of these ranges.

Depending upon the aesthetic requirements of the device once installed, the diffuser may be provided with e.g. a metal or plastic/polymer frame. In some embodiments, it may be desirable for the frame to be manufactured from a timber or timber-look material, e.g. as discussed with respect to the window embodiments.

In some embodiments, it may be desirable to incorporate a “stain glass” effect into the lighting module. Thus, different coloured LEDs may be incorporated into the lighting module 120. Alternatively/additionally, the lighting module 120 may be used to present “images” or multi-colour effects. This may be particularly useful where the lighting module is installed on a wall e.g. in a completely interior or underground room of a dwelling which does not have a window. Thus, while installation of the inventive lighting system in a ceiling may be desirable to produce a natural lighting effect, it may also/alternatively be desirable to install the lighting module 120 on a wall so as to produce a “window” effect or in a ceiling to produce a sky-scape effect.

The window effect may be further enhanced by including an image or representation of a scene such as an exterior view. In some embodiments that image need not be entirely clear or realistic, but may represent the view as if regarded through e.g. frosted glass, glass tiles or a vinyl privacy slick. In some embodiments, the lighting module 120 may be operable couplable with an externally located camera which captures images that are reproduced by the lighting module. In other embodiments, one or more images are programmed into memory component that is used to control the image created by the lighting module. The image may be selected at random, by a user or set to appear according to a timer or time of day. The illumination element/s in the lighting module may comprise e.g. LED and/or LCD components although other components particularly suitable for creating an image effect are contemplated.

Additionally, since in a natural light mode of operation the light emitted from the lighting module mimics the behaviour of at least one characteristic of natural sunlight, it follows that in natural light mode, when the sun no longer provides natural light outside (e.g. during late evening, late night and early morning), the lighting module also ceases to provide light to the room. In this way, the solar powered skylight provides lighting in a manner which is almost identical to a traditional skylight which employs an optical pathway between a roof-mounted dome and a light diffuser installed in the ceiling.

There are several advantages associated with the present invention. Not only does it provide a source of interior lighting which consumes no electricity when powered by the solar module, it provides a source of light which mimics a characteristic (e.g. brightness) of natural sunlight. Thus, light emitted by the lighting module on a bright, sunny day is brighter than light emitted on a cloudy or dull day. In this way, the light emitted from the inventive lighting system is similar to light from a traditional skylight.

However, the present invention avoids many pitfalls of traditional skylights. For example, one or more solar panels used to collect incident sunlight (or heat) and transform it to electricity can be mounted externally onto the roof surface, without removal of tiles, slates, shingles or sections of roofing iron. Furthermore, the solar panels can be located anywhere external to the building where the panel will receive solar energy. Thus, the solar panels may be roof mounted, wall mounted, mounted on a separate structure, the ground or elsewhere. The location of the solar panels is limited only by its ability to receive solar energy and transmit it to the lighting module. Coupling the solar panels and indeed the solar module to one or more lighting modules is a simple matter of wiring the modules together.

A lighting module can be located almost anywhere, including rooms where installation of traditional skylights and windows is virtually impossible. Such locations include e.g. where there are upper stories in the building, existing appliances such as heating/cooling units, hot water systems and attic storage, and/or wiring which obstructs installation of a traditional skylight and where installation of a traditional window would be impractical due to limitations caused by an obstructed view, opposing wall or adjacent construction. Some ideal locations includes hallways, entrances, walk in robes, bathrooms, en suites, and the restroom, kitchen pantries, kitchen splashbacks, garden sheds, garages, basements, cellars and the like. Installation outside may also be desirable for security, aesthetic and other reasons.

While installation of the inventive lighting system is straightforward, removing or relocating it is also easy. Use of spring clips in some embodiments enables the lighting module to be removed from the ceiling/wall sheet and disconnected from the solar module by unplugging. Patching a hole in the ceiling from which a lighting module has been removed is a simple matter. Although a large hole need not be formed as the lighting module may be fastened to the wall/ceiling sheet using adhesive or other fastener/s.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components or group thereof.

It is to be understood that various modifications, additions and/or alterations may be made to the parts previously described without departing from the ambit of the present invention as defined in the claims appended hereto.

1. A solar powered lighting system including:
(a) a solar module adapted to receive solar energy and transform received solar energy into electrical energy; and
(b) a lighting module electrically coupled to the solar module, the lighting module being configurable to emit light using electrical energy generated by the solar module only while the solar module receives solar energy;
wherein the solar module and the lighting module are electrically couplable such that light emitted from the lighting module mimics a characteristic of sunlight from which the solar energy is received.

2. A solar powered lighting system according to claim 1 including a regulator adapted to limit electrical energy supplied to the lighting module from the solar module.

3. A solar powered lighting system according to claim 2, wherein the regulator limits maximum current supplied to the lighting module to minimise heating of and/or damage to light emitters in the lighting module.

4. A solar powered lighting system according to claim 1, wherein the lighting module includes an illumination element having one or more of LEDs arranged:
along an edge of the illumination element; and/or
around a perimeter of the illumination element; and/or
in an array over at least an area of the illumination element; and/or
such that the LEDs are directed toward an inner part of the illumination element.

5. A solar powered lighting system according to claim 4 wherein the LEDs are low profile LEDs and may be selected from a group including strip LEDs and surface mount diodes (SMDs).

6. A solar powered lighting system according to claim 1, further including a diffuser for diffusing light emitted from the lighting module.

7. A solar powered lighting system according to claim 1, wherein the lighting module is configured for installation in a wall or ceiling sheet adjacent a support beam, wherein the lighting module has a casing at least a portion of which has a thickness less than or equal to the wall or ceiling sheet thickness.

8. A solar powered lighting system according to claim 7, wherein at least a portion of the casing has a thickness of less than 20 mm, preferably less than 15 mm and more preferably less than 10 mm, or 8 mm or less.

9. A solar powered lighting system according to claim 1, wherein the lighting module is configured to protrude no more than 20 mm from a mounting surface to which the lighting module has been mounted.

10. A solar powered lighting system according to claim 1, including a plurality of spring clips for releasably mounting the lighting module in a wall or ceiling structure.

11. A solar powered lighting system according to claim 1, the system being couplable with a secondary power source for activating the lighting module in the absence of solar energy.

12. A solar powered lighting system according to claim 1, including a switching module operable by a user to perform one or more of:
disconnecting the lighting module from a power source; and
switching between power sources supplying electrical energy to the lighting module.

13. A solar powered lighting system according to claim 12 wherein the switching module includes a wireless switch operable by the user.

14. A solar powered lighting system according to claim 1, wherein a characteristic of natural sunlight which is mimicked by the lighting module is selected from a group including brightness and colour.

15. A solar powered lighting system according to claim 1, including a controller adapted to control operation of the lighting module to cause a lighting effect selected from a group including:
substantially natural ambient light;
an image;
a colour effect; and
an image effect or colour effect that changes over time.

16. A solar powered lighting system according to claim 15 including a controller configured to control operation of the lighting module to produce the lighting effect, wherein the controller receives image data from a source selected from a group including:
a memory device couplable with the controller;
a camera couplable with the controller.

17. A solar powered lighting system according to claim 1, adapted for installation between studs, the system including one or more frame members adapted to give the appearance of a window effect when installed.

18. A solar powered lighting system according to claim 17, wherein the frame members are configured to achieve recessed window effect when installed.

19. (canceled)
